(19) United States
(12) Patent Application Publication
(10) Pub. No.: US 2015/0050405 A1
(43) Pub. Date: Feb. 19, 2015

(54) SINGLE-USE MIXED DRINK CONTAINER

(71) Applicants: Craig M. Trager, Los Angeles, CA (US); Chad Donella, Studio City, CA (US)

(72) Inventors: Craig M. Trager, Los Angeles, CA (US); Chad Donella, Studio City, CA (US)

(21) Appl. No.: 13/969,082

(22) Filed: Aug. 16, 2013

(51) Int. Cl. B65D 81/32; C12G 3/04

(52) U.S. Cl. CPC B65D 81/3211; C12G 3/04
USPC 426/519; 206/222

(57) ABSTRACT

An individual drink container has a lower container having a void formed therein for holding a liquid; a divider disposed in the void of the lower container, the divider compartmentalizing the void into a plurality of compartments, each compartment being configured to separately hold a liquid, the compartments having open top portions; a foil sealing the top portions of each of the plurality of compartments; a upper container configured to sealingly join to the lower container; and a cutter assembly having a plurality of cutting members, the cutter assembly being held on an internal surface of the upper container with the cutting members facing the foil. When the upper container is rotated, the cutting members are moved into the foil and tearing the foil.

### I. FIELD OF THE INVENTION

The present invention relates generally to single-use drink containers. More specifically, the present invention relates to a single-use mixed drink containers having multiple individually isolated compartments.

### II. SUMMARY OF THE INVENTION

An object of the invention is to provide a convenient single serve mixed drink container in which the individual component ingredients are held separately in compartments of the container. Keeping the component ingredients separate until the single serve mixed drink container is opened allows for the ingredients to maintain a fresher flavor.

An embodiment of the present invention is an individual drink container having a lower container with a void formed therein for holding a liquid; a divider disposed in the void of the lower container, the divider compartmentalizing the void into a plurality of compartments, each compartment being configured to separately hold a liquid, the compartments having open top portions; a foil sealing the top portions of each of the plurality of compartments; a upper container configured to sealingly join to the lower container; and a cutter assembly having a plurality of cutting members, the cutter assembly being held on an internal surface of the upper container with the cutting members facing the foil. When the upper container is rotated, the cutting members are moved into the foil and tearing the foil.

The upper container includes a central orifice surrounded by a lip; threads formed on an outer perimeter surface of the lip; a strainer configured with a plurality of through holes covering the central orifice; and a cap having a threaded interior perimeter configured to sealingly mate with the threads of the lip.

Another embodiment of the present invention is an individual drink container having a first compartment containing a first liquid; a second compartment containing a second liquid different from the first liquid; a foil sealing a top of the first compartment and a top of the second compartment; and a upper container having a cutter assembly disposed in proximity to the foil, the upper container covering and sealing the first compartment and the second compartment.

### III. BRIEF DESCRIPTION OF THE DRAWINGS

These and other features, aspects, and advantages of the present invention will become better understood with regard to the following description, appended claims, and accompanying drawings wherein:

FIG. 1 illustrates an embodiment of the present invention;

FIG. 2 illustrates a plan view of the embodiment of the present invention shown in FIG. 1 with cap removed;

FIG. 3 illustrates a plan view of the embodiment of the present invention shown in FIG. 1 with cap in place;

FIG. 4 illustrates an exploded view of the embodiment of the present invention shown in FIG. 1;

FIG. 5 illustrates a view of cutters of the embodiment of the present invention shown in FIG. 1; and

FIG. 6 illustrates another embodiment of the present invention.

### IV. DETAILED DESCRIPTION OF INVENTION

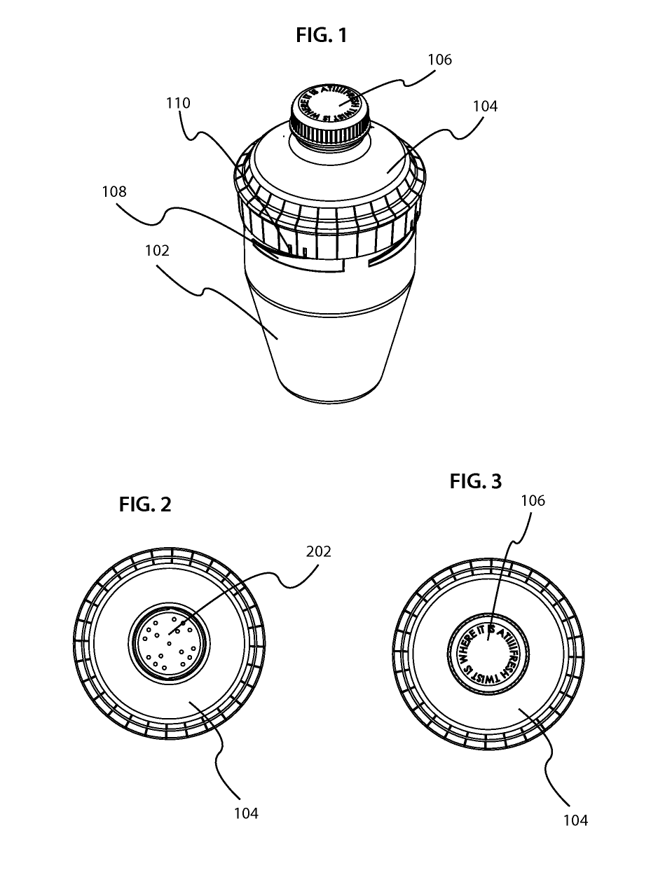

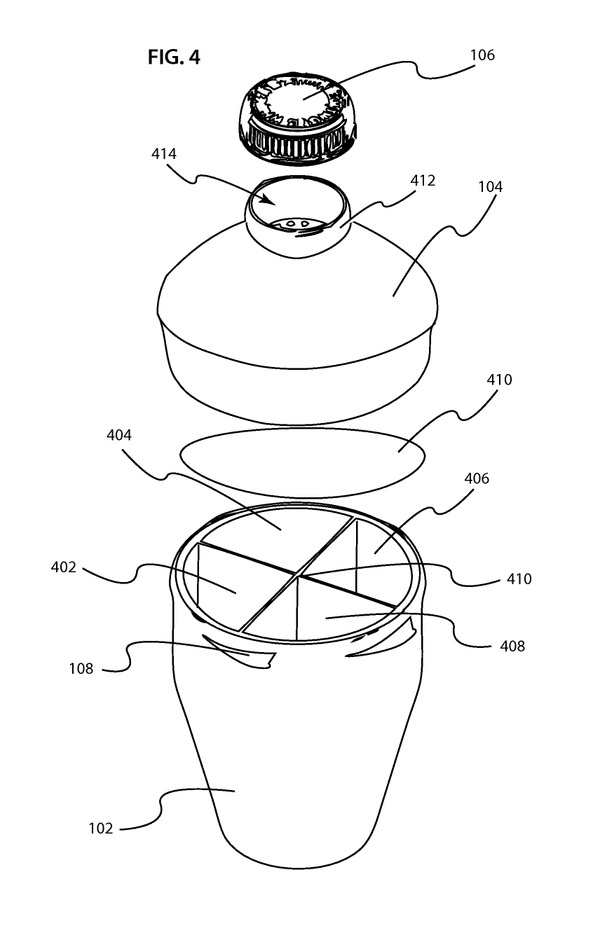

With reference to FIG. 1-5, an embodiment of the present invention is a single serve mixed drink container that includes a lower container 102. An upper container 104 is configured to screwably couple with the lower container 102. Additionally, the upper container 104 includes a cap 106.

The outer surface of the lower container 102 has a plurality of etched threads 108 configured to accept tabs 110 disposed along the lower perimeter of the upper container 104. Once the tabs 110 are secured within the etched threads 108, the upper container 104 is not easily removable from the lower container 102 by rotating a first direction, for example counter-clockwise. However, the upper container 104 is allowed to rotate in a second direction, a clockwise direction for example.

Specifically, the tabs 110 are held within a recessed portion of the etched threads 108. Rotation of the upper container 104 causes the tabs 110 to contact an edge of the etched threads 108, which prevents further rotation in that direction. On the other hand, rotation of the upper container 104 in the second direction causes the tabs 110 to move within the recessed portion of the etched threads 10. The contour of the etched threads 108 causing the upper container 104 to move downward towards the lower container 102 when the upper container 104 is rotated in the second direction.

As shown in FIG. 2, a strainer 202 is provided on the upper container 104 at a position coincident with the cap 106. The strainer 202 is formed with a plurality of holes to allow liquid to pass from the internal spaces of the single serve mixed drink container to the exterior.

Additionally, as shown in FIG. 4, the upper container 104 includes a central orifice 414 disposed at a top surface of the upper container 104. The central orifice 414 provides external access to the interior of the single serve mixed drink container through the strainer 202 when the upper container 104 is coupled to the lower container 102.

An interior void of the lower container 102 is divided by a one or more dividers 410 configured to provide a plurality of compartments 402, 404, 406 and 408. The compartments 402, 404, 406 and 408 form individual liquid holding regions that are sealed from one another. A foil 416, formed of a thin metallic or plastic membrane suitable for use in food containers, seals the top surface of the plurality of compartments 402, 404, 406 and 408.

Moreover, the central orifice 414 includes a surrounding lip 412 dimensioned to receive the screw cap 106. The screw cap 106 may be configured with threads on an internal perimeter surface corresponding to matching threads formed on an outside perimeter surface of the lip 412. Additionally, a foil (not shown) may be provided as a tamper-proof seal across the central orifice 414.

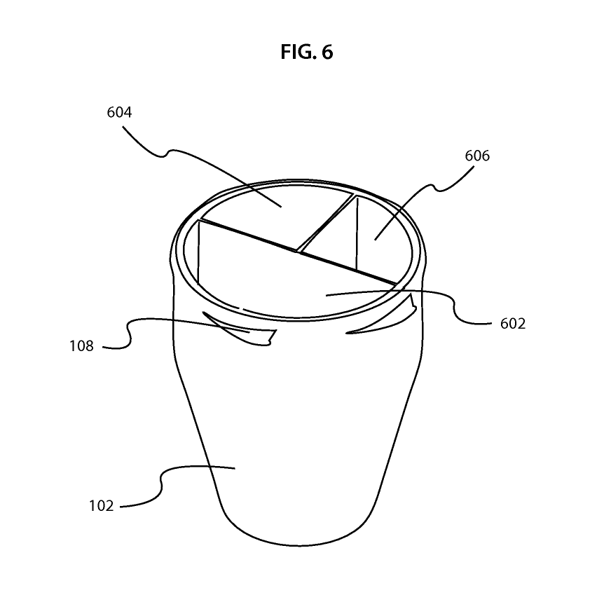

While FIG. 4 shows an embodiment in which each compartment of the plurality of compartments 402, 404, 406 and 408 has identical or nearly identical volume, Alternative embodiments are envisioned as well. For example, the plurality of compartments 402, 404, 406 and 408 may be of different volumes. The volumes of the individual compartments 402, 404, 406 and 408 may be made different by forming a baffled bottom at an appropriate height within the compartments 402, 404, 406 and 408, thus each of the plurality of compartments 402, 404, 406 and 408 has different depths. Alternatively, the one or more dividers 410 may be oriented such that the compartments 402, 404, 406 and 408 have different cross-sectional areas. Furthermore, the dividers 410 may be formed of other shapes instead of the cross-shaped shown in FIG. 4 or the T-shaped shown in FIG. 6. The dividers 410 may have curved shapes for example.

Alternatively, instead of the plurality of compartments 402, 404, 406 and 408 consisting of four regions, an embodiment of the present invention may have three compartments 602, 604 and 606, as shown in FIG. 6.

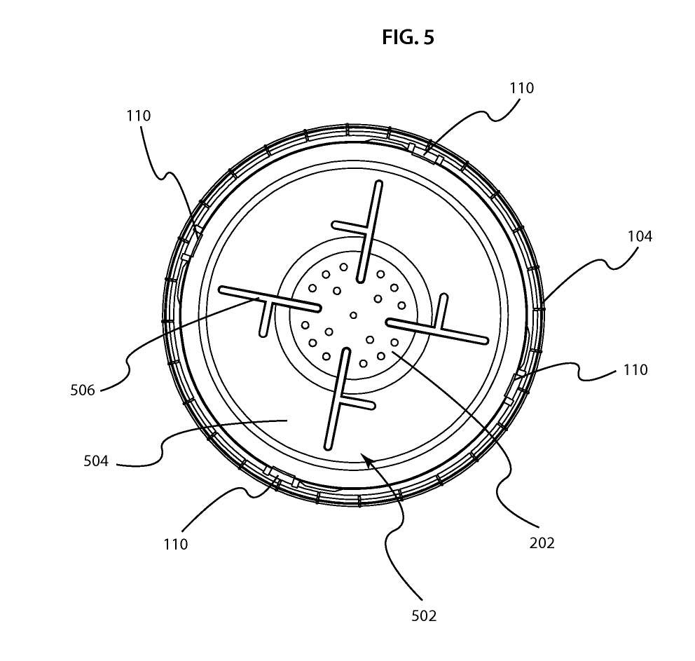

The foil 416 is selected from materials and dimensioned to provide adequate strength for maintaining the plurality of compartments 402, 404, 406 and 408 in a sealed state during storage and transportation of the single serve mixed drink container. Moreover, the foil 416 must tear easily upon actuation of a cutter assembly 502, shown in FIG. 5, disposed in the container upper container 104.

By rotating the upper container 104 against the lower container 102, the upper container 104 causes the cutter assembly 502 to plunge into the foil 416 and at least partially tear the foil 416 at positions corresponding to each of the plurality of compartments 402, 404, 406 and 408.

The cutter assembly 502 is formed of an annular insert 504 having a plurality of cutting members 506 radially disposed and aligned with the plurality of compartments 402, 404, 406 and 408. In the shown embodiment, the cutting members 506 are formed as generally T-shaped and have a sloped bottom surface. However, alternative shapes may be used as well.

In a storage configuration the cutter assembly 502 is held by the upper container 104 such that the cutting members 506 are disposed at a non-contact distance above the foil 416. However, as the upper container 104 is rotated in the second direction with respect to the lower container 102, the cutting members 506 are brought into contact with the foil 416. Continued rotation of the upper container 104 in the second direction causes the cutting members 506 to tear the foil 416 in regions corresponding to each of the plurality of compartments 402, 404, 406 and 408. Thus, rotation of the upper container 104 causes each of the plurality of compartments 402, 404, 406 and 408 to be unsealed at substantially the same time.

Once the plurality of compartments 402, 404, 406 and 408 are unsealed, the single serve mixed drink container is vigorously shaken to mix the liquids together in a void formed between the top of the lower container 102 and a bottom surface of the strainer 202. After the single serve mixed drink container is shaken sufficiently to mix the liquids contained therein, the cap 106 is removed and the contents of the single serve mixed drink container are poured into an appropriate drinking glass, with or without ice.

### Example 1

### Sea Breeze

In a first example, a single portion of a sea breeze is described implemented in the single serve mixed drink container of the present invention. The recipe for a sea breeze is as follows:
1 part vodka;
1 part grapefruit juice; and
3 parts cranberry juice.

Consequentially, the compartments of the lower container 102 are dimensioned to hold 40 ml of vodka in a first compartment 604, 40 ml of grapefruit juice in a second compartment 606, and 120 ml of cranberry juice in a third compartment 602.

### Example 2

### Sex on the Beach

In a second example, a single portion of a Sex on the Beach cocktail is described implemented in the single serve mixed drink container of the present invention. The recipe for a Sex on the Beach is as follows:
2 parts vodka;
1 part peach schnapps;
2 parts orange juice; and
2 parts cranberry juice.

Consequentially, the compartments of the lower container 102 are dimensioned to hold 40 ml of vodka in a first compartment 402, 20 ml of peach schnapps in a second compartment 404, 40 ml of orange juice in a third compartment 406, and 40 ml of cranberry juice in a fourth compartment 408.

Other cocktails may be implemented with the present invention using any number of alcoholic and non-alcoholic liquids. Alcoholic liquids may be vodka, gin, rum and tequila, for example. Non-alcoholic liquids may be juices, carbonated liquids and syrups, for example.

The single serve mixed drink container of the present invention can be implemented as a disposable container manufactured of recyclable materials, such as plastic, metal, and glass. Additionally, various materials may be used in combination, such as a glass lower container 102, metal upper container 104 and plastic cutter assembly and dividers.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. A single-use mixed drink container comprising:
a lower container having a void formed therein for holding a liquid;
a divider disposed in the void of the lower container, the divider compartmentalizing the void into a plurality of compartments, each compartment being configured to separately hold a liquid, the compartments having open top portions;
a foil sealing the top portions of each of the plurality of compartments;
a upper container configured to sealingly join to the lower container; and
a cutter assembly having a plurality of cutting members, the cutter assembly being held on an internal surface of the upper container with the cutting members facing the foil.

2. The single-use mixed drink container as in claim 1, wherein rotation of the upper container moves the cutting members into the foil and tears the foil.

3. The single-use mixed drink container as in claim 2, wherein the lower container includes etched threads along an outside perimeter thereof and the upper container includes a plurality of tabs along a bottom edge thereof, the tabs being dimensioned and configured to reside within a recess formed by the respective etched threads.

4. The single-use mixed drink container as in claim 3, wherein the etched threads prevent rotation of the upper container in an unscrewing direction with respect to the lower container by blocking movement of the tabs in the unscrewing direction, and
wherein the etched threads allow rotation of the upper container in the direction that moves the cutting members into the foil.

5. The single-use mixed drink container as in claim 1, wherein the upper container further comprises:
a central orifice surrounded by a lip;
threads formed on an outer perimeter surface of the lip;
a strainer configured with a plurality of through holes covering the central orifice; and
a cap having a threaded interior perimeter configured to sealingly mate with the threads of the lip.

6. The single-use mixed drink container as in claim 1, wherein at least one compartment of the plurality of compartments has a different volume.

7. The single-use mixed drink container as in claim 6, further comprising at least one baffled bottom disposed in the least one of compartment to lower the volume of the at least one compartment.

8. The single-use mixed drink container as in claim 6, wherein the divider compartmentalizes the void into uneven cross-sectional areas for each of the plurality of compartments.

9. The single-use mixed drink container as in claim 5, wherein the upper container forms a mixing void between a top surface of the foil and a bottom surface of the strainer, the mixing void providing a volume for intermixing the contents of the individual drink container.

10. A single-use mixed drink container comprising:
a first compartment containing a first liquid;
a second compartment containing a second liquid different from the first liquid;
a foil sealing a top of the first compartment and a top of the second compartment; and
a upper container having a cutter assembly disposed in proximity to the foil, the upper container covering and sealing the first compartment and the second compartment.

11. The single-use mixed drink container as in claim 10, wherein rotation of the upper container moves the cutting members into the foil and tears the foil.

12. The single-use mixed drink container as in claim 11, wherein the lower container includes etched threads along an outside perimeter thereof and the upper container includes a plurality of tabs along a bottom edge thereof, the tabs being dimensioned and configured to reside within a recess formed by the respective etched threads.

13. The single-use mixed drink container as in claim 12, wherein the etched threads prevent rotation of the upper container in an unscrewing direction with respect to the lower container by blocking movement of the tabs in the unscrewing direction, and
wherein the etched threads allow rotation of the upper container in the direction that moves the cutting members into the foil.

14. The single-use mixed drink container as in claim 10, wherein the upper container further comprises:
a central orifice surrounded by a lip;
threads formed on an outer perimeter surface of the lip;
a strainer configured with a plurality of through holes covering the central orifice; and
a cap having a threaded interior perimeter configured to sealingly mate with the threads of the lip.

15. The single-use mixed drink container as in claim 10, further comprising a third compartment containing a third liquid different from the first liquid and the second liquid.

16. The single-use mixed drink container as in claim 15, further comprising a fourth compartment containing a fourth liquid different from the first liquid, the second liquid and the third liquid.

17. The single-use mixed drink container as in claim 16, wherein at least one compartment has a different volume.

18. The single-use mixed drink container as in claim 17, further comprising at least one baffled bottom disposed in the least one of compartment to lower the volume of the at least one compartment.

19. The single-use mixed drink container as in claim 17, wherein the divider compartmentalizes the void into uneven cross-sectional areas for each of the plurality of compartments.

20. The single-use mixed drink container as in claim 14, wherein the upper container forms a mixing void between a top surface of the foil and a bottom surface of the strainer, the mixing void providing a volume for intermixing the contents of the individual drink container.

21. A method for making a mixed drink using a single-use mixed drink container, the method comprising:
twisting an upper container against a lower container to tear a foil disposed therein, the foil isolating a plurality of liquid holding compartments from one another;
shaking the single-use mixed drink container to mix a plurality of liquids held in respective liquid holding compartments of the plurality of liquid holding compartments to produce a mixed drink;
removing a cap from a top surface of the upper container; and
pouring the mixed drink into a drinking container through a strainer disposed underneath the cap.
